(19) United States
(12) Patent Application Publication
(10) Pub. No.: US 2005/0178017 A1
(43) Pub. Date: Aug. 18, 2005

(54) Non-contact electronic level

(76) Inventors: Chao-Chi Huang, Taipei (TW); Chih-Yung Cheng, Taipei (TW); Kung-Ho Su, Taipei (TW); Ching-Horng Hsiao, Taipei (TW)

Correspondence Address: Raymond Sun, 12420 Woodhall Way, Tustin, CA, 92782, US

(21) Appl. No.: 10/933,985

(22) Filed: Sep. 3, 2004

(30) Foreign Application Priority Data
Feb. 17, 2004 (TW) 093202210

(51) Int. Cl. G01C 15/10

(52) U.S. Cl. 33/366.23

(57) ABSTRACT

A non-contact electronic level has a light source, a vial having an air bubble and positioned to be irradiated by light from the light source, a photo sensor located at a position corresponding to the air bubble at a fixed distance from the vial, with the photo sensor capturing an image of the air bubble after the vial is irradiated by the light source, and an image processing unit electrically coupled to the photo sensor and converting the image of the air bubble into an electronic level signal.

### BACKGROUND OF THE INVENTION

1. Field of the Invention

The present invention relates to a level, and more particularly, to a non-contact electronic level.

2. Description of the Prior Art

Various forms of levels have been used as devices to enable the operator to determine when a particular surface is horizontal. Early levels consisted of a body of liquid in an open vessel since liquid is known to form a flat, horizontal surface. The surface of the liquid formed a reference surface which served as the standard against which the horizontal character of a second surface was estimated (e.g., an inclination direction and an inclination angle). This basic principle has evolved into a bubble level where a bubble is trapped in a body of liquid, with the liquid being enclosed in an upwardly curved, clear tube. An improved design uses a transparent ball instead of the clear tube for holding the liquid enabling the bubble to move in all four directions of the plane thereon so that the user does not need to pivot the level at an angle of ninety degrees over and over again while measuring.

FIG. 1 illustrates another conventional level 100 which has a casing 102, an electrolyte 104 which has an air bubble 108 floating thereon, and a plurality of metal electrodes 106. The electrolyte 104 is placed in the casing 102, and the metal electrodes 106 pass through the casing 102 and soak in the electrolyte 104. If the air bubble 108 moves along the surface of the casing 102 when the level 100 is tilted, the resistance between the metal electrodes 106 will change as the air bubble 108 moves. Therefore, the horizontal position of the level 100 can be detected using the change of such resistance. However, the level 100 in FIG. 1 still suffers from numerous drawbacks:

1. After the metal electrodes 106 have been used for a period of time, the surface of the metal electrodes 106 will be corroded and the resistance thereof will be affected, such that the accuracy and sensitivity of the level 100 are reduced.

2. The electrolyte 104 must be changed regularly to maintain a proper ion concentration.

3. Even if the metal electrodes 106 and the electrolyte 104 are changed regularly, the resistance can still be varied by the gradual corrosion of the electrodes 106 and the gradual consumption of the electrolyte 104, thereby affecting the accuracy and sensitivity of the level 100.

4. The electrolyte 104 is vulnerable to the temperature of the environment, such that the temperature variation of the surrounding environment will affect the conductivity of the electrolyte 104, thereby reducing the accuracy and sensitivity of the level 100.

### SUMMARY OF THE INVENTION

It is an object of the present invention to provide a non-contact electronic level that obtains a precise electronic level signal so as to enhance the precision, sensitivity, and testing reliability of the electronic level.

It is another object of the present invention to provide a non-contact electronic level which avoids using corrosive electrolytes, but which uses light as a medium to effectively extend the life of electronic level.

In order to achieve the objectives of the present invention, there is provided a non-contact electronic level that has a light source, a vial having an air bubble and positioned to be irradiated by light from the light source, a photo sensor located at a position corresponding to the air bubble at a fixed distance from the vial, with the photo sensor capturing an image of the air bubble after the vial is irradiated by the light source, and an image processing unit electrically coupled to the photo sensor and converting the image of the air bubble into an electronic level signal.

The present invention also provides a method of measuring a level which includes using a light source to irradiate a vial having an air bubble therein, capturing an image of the air bubble after the vial is irradiated by the light source, converting the image of the air bubble into an electronic level signal, and adjusting the inclination of the air bubble based on the electronic level signal.

### BRIEF DESCRIPTION OF THE DRAWINGS

FIG. 1 illustrates a conventional level.

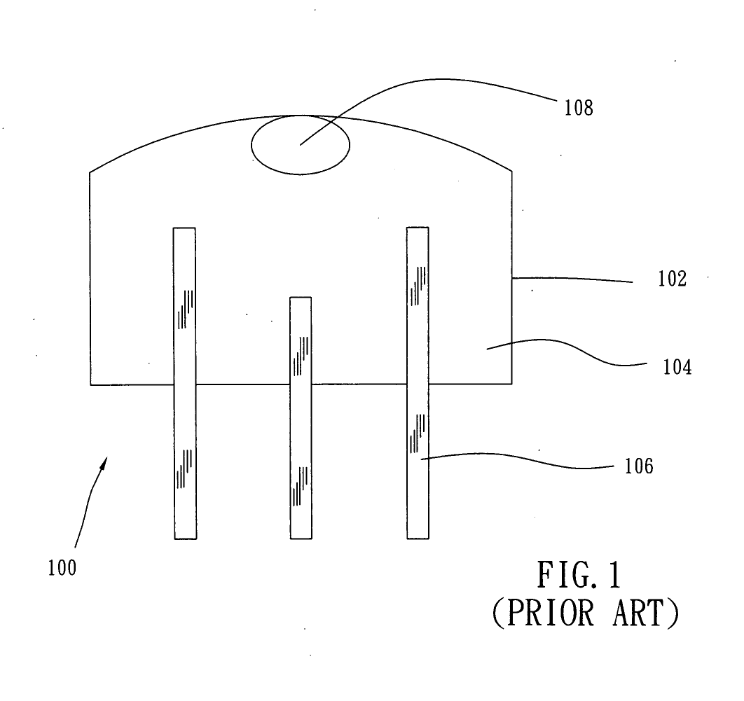

FIG. 2A illustrates a non-contact electronic level according to one embodiment of the present invention showing the vial tilted.

FIG. 2B is a schematic diagram showing a processed image of an air bubble with the vial in a tilted position of the level of FIG. 2A.

FIG. 3A illustrates the non-contact electronic level of FIG. 2A showing the vial in a perfectly-horizontal position.

FIG. 3B is a schematic diagram showing a processed image of an air bubble with the vial in a perfectly-horizontal position of the level of FIG. 3A.

FIG. 4 illustrates the non-contact electronic level of FIGS. 2A and 3A being connected to a circuit device according to one embodiment of the present invention.

FIG. 5 illustrates the non-contact electronic level of FIGS. 2A and 3A being connected to a testing object according to one embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

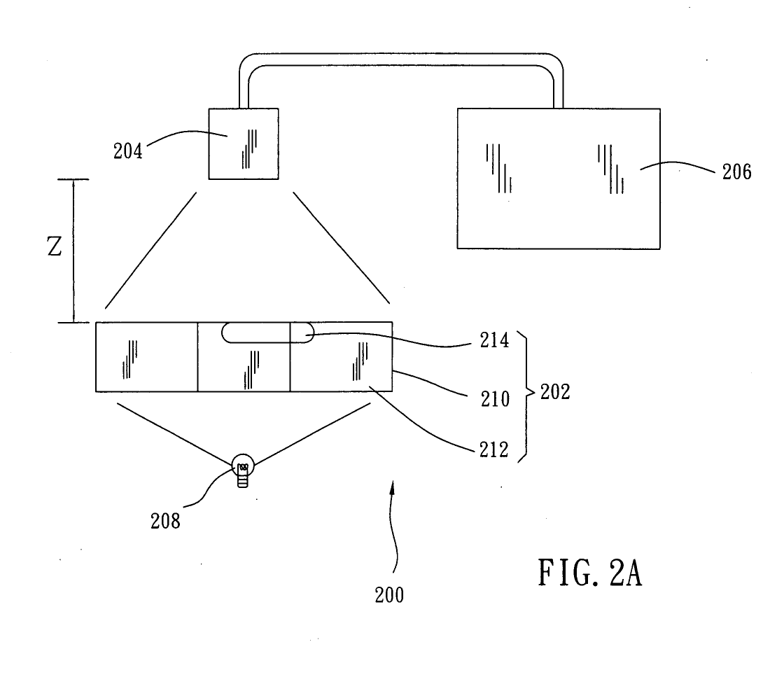

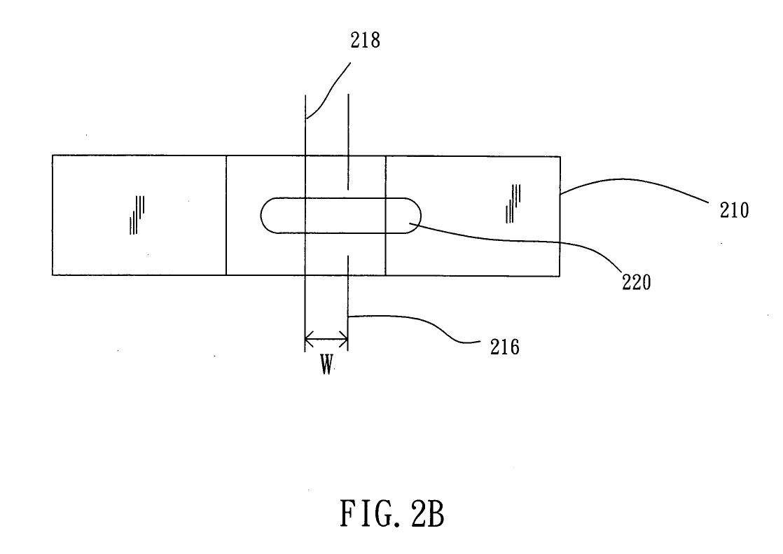

Referring to FIGS. 2A and 2B, a tilted non-contact electronic level 200 according to one embodiment of the present invention has a vial 202, a photo sensor 204, and an image processing unit 206. The vial has an air bubble 214 provided therein for receiving light from a light source 208. The light source 208 can be an electroluminescent (EL) board, a light emitting diode (LED), a light bulb, a fluorescent lamp, a cathode ray tube, and any similar device. The photo sensor 204 is located at a position corresponding to the vial 202 at a fixed distance Z, and the photo sensor 204 can be a charge coupled device, a complementary metal oxide semiconductor, or any similar device. The image processing unit 206 is electrically connected to the photo sensor 204, and can be a personal computer (PC), a micro-controller, a digital circuit, an application-specific integrated circuit (ASIC), or any similar device.

The vial 202 has a transparent tube 210 and a liquid 212 that is disposed inside the transparent tube 210, with the air bubble 214 floating on the surface of the liquid 212. In general, the transparent tube 210 is usually made of glass or plastic. If the vial 202 is tilted, the air bubble 214 will move to the upper section of the transparent tube 210. On the other hand, if the vial 202 is disposed in a perfectly-horizontal state, the air bubble 214 will be located at the center position of the transparent tube 210. The photo sensor 204 captures the image 220 of the air bubble 214 when the transparent tube 210 is irradiated by the light source 208, and the image processing unit 206 can calculate the image 220 to obtain the relative displacement W (which can be a positive value) between the center position of the air bubble image 220 and the center position of the transparent tube 210 in order to determine whether or not the vial 202 is disposed in a perfectly-horizontal state.

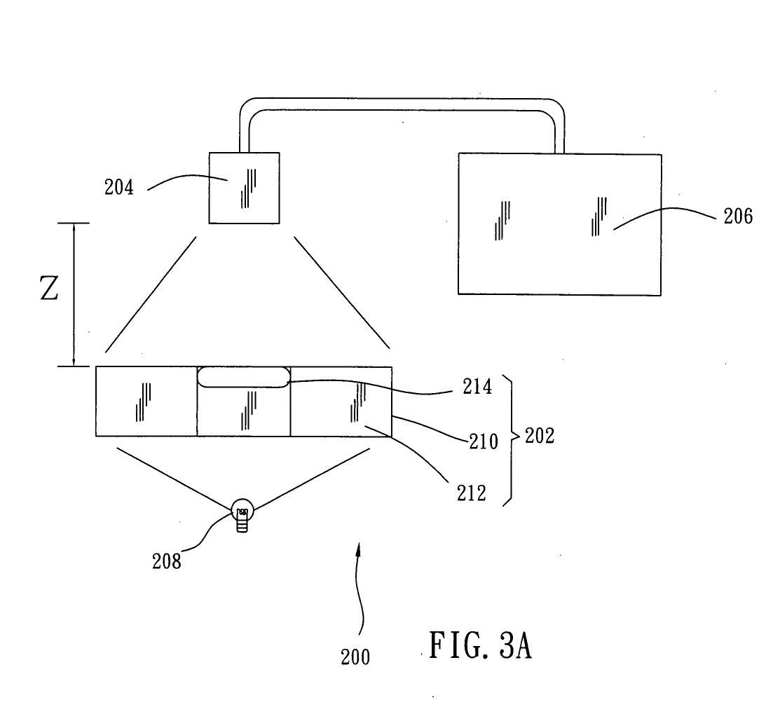

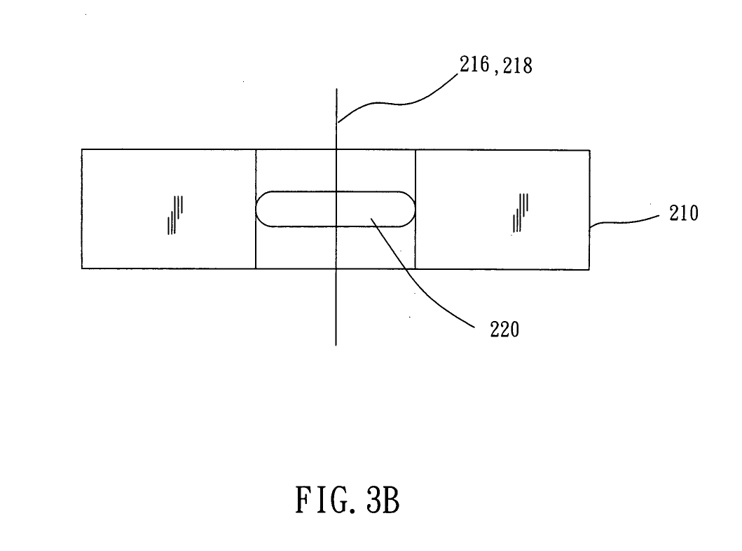

FIGS. 3A and 3B illustrate the same level 200 of FIGS. 2A and 2B when the vial 202 is disposed in a perfectly-horizontal state. After the air bubble image 220 is processed by the image processing unit 206, the relative displacement between the center position of the air bubble image 220 and the center position of the transparent tube 210 is zero.

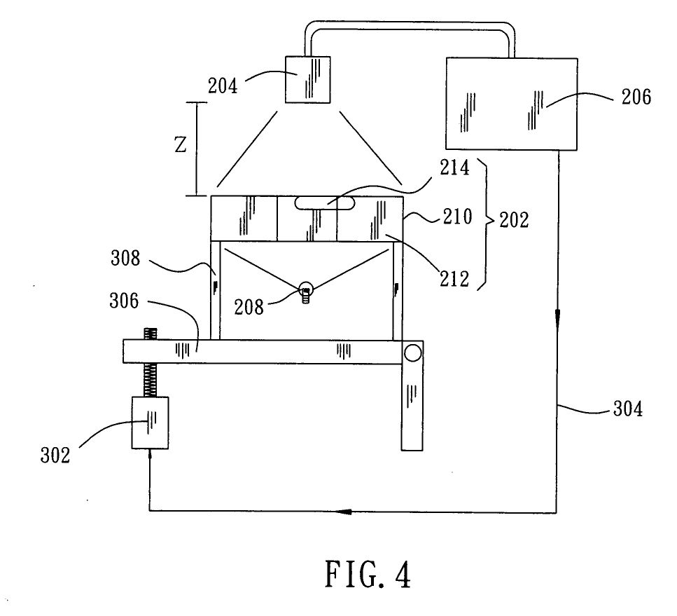

FIG. 4 shows the non-contact electronic level 200 being connected externally to a circuit device 302. The circuit device 302 can be a motor with a control circuit, and the image processing unit 206 can be used for outputting an electronic level signal 304 to the circuit device 302 as a feedback signal for controlling the circuit device 302 to adjust the inclination of the vial 202. Specifically, the photo sensor 204 captures the air bubble image 220 after the air bubble 214 is irradiated by the light source 208. An electronic level signal 304 is outputted after the air bubble image 220 is processed by the image processing unit 206. The electronic level signal 304 serves as a feedback signal for the externally connected circuit device 302.

Continuing to refer to FIG. 4, the vial 202 is placed on a base 308, and the base 308 is further positioned on a platform 306. After the electronic signal 304 is received by the circuit device 302, the motor of the circuit device 302 will be activated to adjust the inclination of the platform 306, thereby adjusting the inclination of the air bubble 214 to cause the vial 202 to be positioned horizontally.

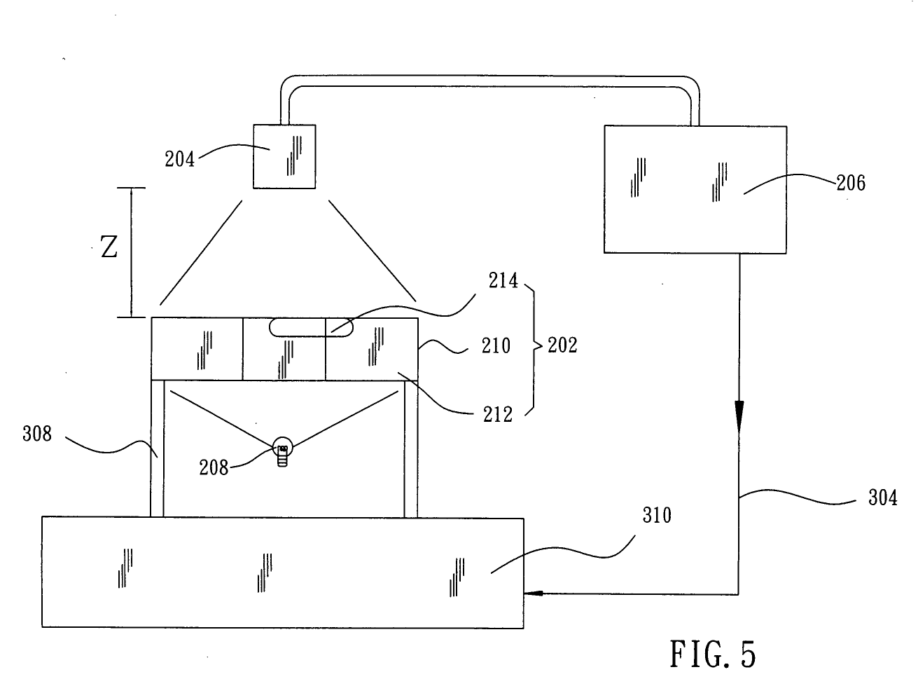

FIG. 5 shows the non-contact electronic level 200 being connected to a testing object. In FIG. 5, the non-contact electronic level can be placed on a testing object 310, such as a protractor, a measuring device, or a measuring instrument required to be set up horizontally with high precision, so as to measure the inclination of the testing object 310.

Throughout the various embodiments of the present invention, the photo sensor 204 is used to capture the image of the air bubble 214, and the image processing unit 206 is used to process the air bubble image 220 to output a high-precision electronic level signal 304. However, the air bubble image 220 can be captured and processed by other known devices, and is not limited to the photo sensor 204 and the image processing unit 206.

In summary, the non-contact electronic level 200 of the present invention has at least the following advantages:

1. The non-contact electronic level 200 uses the photo sensor 204 to capture the air bubble image 220 and precisely detect the position of the air bubble 214 regardless of whether the level 200 is in a dynamic state or in a static state for the image processing unit 206 to output a precise electronic level signal 304 as a basis for determining the horizontal level.

2. The non-contact electronic level 200 uses the image processing unit 206 to process the air bubble image 220 and to correctly compute the distance between the center position 216 of the air bubble 214 and the center position 218 of the transparent tube 210, so as to determine the inclination of the vial 202 or the testing object 310.

3. After the air bubble image 220 of the non-contact electronic level 200 is processed by the image processing unit 206, a precise electronic level signal 304 can be outputted as a feedback signal to the externally connected circuit device 302 for adjusting the inclination of the vial 202.

4. The temperature of the environment will not affect the performance of the non-contact electronic level 200 because the level 200 uses a non-contact measuring method.

While the description above refers to particular embodiments of the present invention, it will be understood that many modifications may be made without departing from the spirit thereof. The accompanying claims are intended to cover such modifications as would fall within the true scope and spirit of the present invention.

1. A non-contact electronic level, comprising:
a light source;
a vial having an air bubble and positioned to be irradiated by light from the light source;
a photo sensor located at a position corresponding to the air bubble at a fixed distance from the vial, the photo sensor capturing an image of the air bubble after the vial is irradiated by the light source; and
an image processing unit electrically coupled to the photo sensor and converting the image of the air bubble into an electronic level signal.

2. The level of claim 1, wherein the vial has a transparent tube and a liquid, with the liquid disposed inside the transparent tube, and wherein the air bubble is located on the surface of the liquid such that the liquid moves when the vial tilts.

3. The level of claim 2, wherein the image processing unit processes the image of the air bubble to obtain a relative displacement between a center position of the air bubble and a center position of the transparent tube.

4. The level of claim 3, wherein the displacement between the center position of the air bubble and the center position of the transparent tube is zero when the vial is horizontal.

5. The level of claim 3, wherein the displacement between the center position of the air bubble and the center position of the transparent tube is a positive value when the vial is tilted.

6. The level of claim 1, wherein the light source is selected from the group that includes an electroluminescent board, a light emitting diode, a light bulb, a fluorescent lamp, and a cathode ray tube.

7. The level of claim 1, wherein the photo sensor is selected from the group that includes a charge coupled device and a complementary metal oxide semiconductor.

8. The level of claim 1, wherein the image processing unit is selected from the group that includes a personal computer, a micro-controller, a digital circuit, and an application specific integrated circuit.

9. The level of claim 1, further including a circuit device that is coupled to the image processing unit, with the image processing unit providing the electronic level signal to the circuit device, and with the circuit device adjusting the inclination of the vial based on the electronic level signal.

10. The level of claim 9, further including a base that supports the vial, and with the circuit device coupled to the base to adjust the inclination of the base based on the electronic level signal.

11. A method of measuring a level, comprising:
using a light source to irradiate a vial having an air bubble therein;
capturing an image of the air bubble after the vial is irradiated by the light source; and
converting the image of the air bubble into an electronic level signal.

12. The method of claim 11, further comprising:
adjusting the inclination of the air bubble based on the electronic level signal.

13. The method of claim 12, further comprising:
using the electronic level signal as a feedback signal of a circuit device for adjusting the inclination of the air bubble.

14. A non-contact electronic level, comprising:
a vial having an air bubble;
a photo sensor located at a position corresponding to the air bubble at a fixed distance from the vial, the photo sensor capturing an image of the air bubble; and
an image processing unit electrically coupled to the photo sensor and converting the image of the air bubble into an electronic level signal.
